(19) United States
(12) Patent Application Publication
(10) Pub. No.: US 2019/0378084 A1
(43) Pub. Date: Dec. 12, 2019

(54) STORAGE SYSTEM COMPRISING A DETECTION ARRANGEMENT ASSIGNED TO THE STORAGE AREA

(71) Applicant: TEDALOS IPR OG, Biedermannsdorf (AT)

(72) Inventor: Thomas Tritremmel, Biedermannsdorf (AT)

(21) Appl. No.: 16/483,311

(22) PCT Filed: Jan. 30, 2018
(86) PCT No.: PCT/AT2018/060027

§ 371 Date: Aug. 2, 2019

(30) Foreign Application Priority Data
Feb. 3, 2017 (AT) A 50086/2017

(51) Int. Cl. G06Q 10/08; B65G 1/137; G06K 19/08; G01G 19/414

(52) U.S. Cl. CPC G06Q 10/087; G06Q 10/0833; G01G 19/4144; G06K 19/08; B65G 1/1378

(57) ABSTRACT

A storage system for monitoring logistics systems, comprises at least one storage area for stored goods and at least one detection arrangement that is assigned to the storage area for identifying the stored goods. The detection arrangement comprises at least one weight sensor and at least one further sensor for identifying the stored goods, wherein the weight sensor is linked to the further sensor and configured and arranged to trigger a recognition process by the further sensor in response to a change in the measured weight.

The invention relates to a storage system for monitoring logistic systems having at least one storage location for a stored item and having at least one detection arrangement assigned to the storage location for identifying the stored item stored at the storage location, which detection arrangement comprises at least one weight sensor and at least one further sensor for identifying the stored item, wherein the weight sensor is connected to the further sensor, and the weight sensor is designed to trigger a recognition process of the further sensor when the measured weight changes.

From WO 2016/166698 A1 a storage system is known, which can detect by a detection arrangement at the storage place a removal, storage or change of a stored item, and can pass this information on to a computer for the production of a stock list. In addition, an identification means is provided for the recognition of a code that identifies the person changing the stock. A system of this type is very complex to set up and not very suitable for retrofitting into an existing warehouse, as energy supply and data lines have to be laid to each storage location. If the detection arrangements are equipped with energy storage devices, this is usually not practicable, since common means of identification, such as RFID recognition modules, consume a lot of energy and the storage devices are emptied quickly as a result.

WO 2005/088494 A1 describes storage systems which have gravimetric sensor rows or sensor matrices, which detect the movements of the stored items and transmit corresponding signals to a computing unit via a communication network. Such systems are more energy-efficient, but purely gravimetric sensor technology does not provide clear identification of the stored items. However, the installation of additional sensors for unambiguous detection brings with it the problem of additional energy consumers.

DE 10 2013 004 594 A1 describes a sensor device which initiates a recognition process when the weight of the stored item changes. The sensor device identifies a stored item at a storage location. Although this system is very energy-efficient, it is very rigid because each storage location must be equipped with such a sensor device, which is both structurally complex and expensive. In addition, a costly retrofit must be carried out if the storage system is modified or expanded.

It is thus the object of the invention to overcome the problems described and to provide a storage system or method for monitoring logistic systems that can be operated as energy-efficiently as possible and can be easily installed in existing warehouses without having to install supply or data lines on a large scale, and that is as flexible and easy to change as possible.

This is solved according to the invention by arranging an operationally separable interface between the detection arrangement and the storage location so that the detection arrangement can be separated from the storage location and is therefore mobile.

In the case of a respective embodiment of the gravimetric sensor, the measurement of the weight consumes hardly any or no energy if the weight remains the same. However, it is usually necessary to determine further properties, the type of stored item or the identity of the stored item. This requires at least one more sensor. Operation of this sensor is usually energy-intensive but at the same time only necessary if the stored item is being removed from the storage location, placed on the storage location or otherwise manipulated. By triggering the recognition process when the weight changes, it is prevented that the sensor for identification has to carry out recognition processes at regular intervals in order to detect a change. Thus a great deal of energy is saved, which also makes an energy supply possible through a local energy storage device. This means that no complicated supply is necessary and the detection arrangement can be easily integrated into existing warehouses. Of course, further recognition processes can still be carried out at regular intervals, if necessary. However, the frequency of these security measurements can be greatly reduced, for example to three security measurements per day or less. The frequency of the security measurements can also be made dependent on the number of stock movements per time of the warehouse or only of the specific storage location.

In addition to the unique identification of the stored item, the weight sensor, the identification sensor or other sensors, such as optical sensors or temperature sensors, can also be used to measure other parameters or information about the stored item. For example, if only part of the stored items is removed from the warehouse, the weight sensor can record the exact quantity removed, or the temperature of the stored items can be measured.

An embodiment is particularly energy-saving in which the sensor that carries out the identification, or possibly other sensors as well, can be put into a standby state between two necessary recognition processes. If no change in weight is detected, no measurement is usually necessary and the sensor can be brought into idle state or, particularly advantageous, switched off completely.

The sensor for identification of the stored items can be designed in different ways. However, the use of a radio sensor, an RFID recognition sensor, an optical sensor, in particular barcode and QR code readers, or a magnetic sensor is advantageous because they can easily and quickly identify stored items unambiguously. In principle, recognition can be carried out by pure measurements without interaction with identification marks on the stored items, but it is particularly advantageous if the stored items or, if applicable, their transport cover carries an identification device such as a barcode or an RFID chip. By reading this means of identification by an appropriate sensor, the stored items can be determined unambiguously in a quick, simple and energy-saving manner.

As a rule, the range of the sensors for identification should be set so that their reception range covers only a small range. This saves energy and ensures that no stored item is mistakenly identified in a neighboring storage location. If the identification is carried out by reading an identification means, it makes sense to arrange the identification means at a predefined location on the stored item, for example at a corner, or, if necessary, at several predefined locations, such as two opposite corners. If the sensor for identification of the identification means is arranged in the detection arrangement or the detection arrangement itself is arranged in such a way that the sensor is close to the identification means when the stored items have been readily stored, a particularly low range of the sensor, for example a few centimeters, is sufficient. This is particularly advantageous when using uniform storage containers, such as uniformly designed containers or pallets.

If the detection arrangement is connected to a warehouse center, this warehouse center can create a warehouse list or organize the warehouse. Especially in a complex warehouse, this is very important for the management of the warehouse. The warehouse center is usually designed in the form of a warehouse computer which continuously receives data from the detection arrangements about storage, retrieval and other changes to the warehouse and, if necessary, exchanges further data with them. The connection can be made via a wire connection, such as a classic data cable connection, or wirelessly, e.g. via WLAN. Depending on the embodiment, corresponding communication units shall be provided in the detection arrangements or in the storage locations. It can also be advantageous to route the wire connection over the storage location and to continue the wire connection in the detection arrangement via an interface. The connection with the warehouse center can be continuous, but it can also be repeatedly interrupted, which saves additional energy.

If the detection arrangement is equipped with a light and/or acoustic source, such as a single or multicolored LED and/or a loudspeaker, signals can be emitted which facilitate the processing of the warehouse. The system can also indicate incorrectly stored items, empty energy storage devices or other conditions.

If the storage system is designed in such a way that the warehouse center can send a localization signal to one or more detection arrangements, thereby bringing the light and/or acoustic source into a changed state, this additionally facilitates storage work. The localization signals may contain different additional information. For example, when searching for a stored item, the warehouse center can send a signal to the corresponding detection arrangement indicating how many stored items are to be removed. This then causes an LED to light up or flash in a specific color. This makes it easier for the searching person to find the storage location. If said person removes the stored items or a part thereof, this is registered by the detection system, the information is forwarded to the warehouse center and the LED is switched off again. This can be further developed at will, for example in that all other or all detection arrangements surrounding the searched stored items generate other order signals in order to further increase the distinctiveness between the searched stored items and the others. Stock transfer processes for optimizing the warehouse and various other processes can also be displayed in this way. Such pick-by-light systems, put-by-light systems and others of this kind are already well known and often applied in practice, as they facilitate warehouse work and reduce the number of errors. Systems of this type can be designed in many different ways, for example, confirmation mechanisms such as buttons or switches can be provided, which the warehouse worker actuates when he has found the storage location. Identification mechanisms can also be provided that uniquely identify the warehouse worker. But it is precisely the automatic change in weight that makes it possible to dispense with the installation of actuating mechanisms.

Depending on the embodiment, it may also be advantageous to arrange the light and/or acoustic source directly at the storage location and to control it via a connection to the detection arrangement, optionally with a corresponding interface between the storage location and the detection arrangement.

When retrofitting an existing warehouse, it is particularly advantageous to use embodiments of detection arrangements that provide an energy storage device and communicate with the central warehouse via a wireless connection. This means that installation in the existing system can be carried out very quickly and cost-effectively.

According to the invention, the detection arrangement can be separated from the storage location. This makes the storage system even more flexible. This allows the detection arrangement to be moved from one storage location to another without major conversion work. The relocation of the detection arrangement can take place without or with stored items currently assigned to it.

Due to the mobility of the detection arrangement, the warehouse can also be continuously optimized in terms of efficiency, i.e. rearranged, which is common practice in many production plants with variable orders, without having to carry out time-consuming reprogramming. At the same time, the advantages of the embodiments described can be continuously used not only in a central warehouse but also variably and distributed in operation, e.g. on different production lines. A localization of the detection arrangement, or of the goods associated with it in the system, can also be easily achieved by light/acoustics. Individual buffer storage locations within, outside or near the actual storage system could also be provided, which are only intended for the temporary storage of stored items, if this is necessary, for example, due to a bottleneck in storage personnel or in the course of a stock relocation.

It is advantageous if the storage location that is assigned to the detection arrangement can be identified by it. This can be carried out, for example, by an additional RFID chip at the storage location. For the identification of the storage location, either the same sensor as for the identification of the stored items or an additional sensor can be used. In this way, the detection arrangement can immediately determine its position when a new allocation to a storage location is made and, if necessary, transmit a signal to the warehouse center. If the recognition process of the storage location and others is carried out when a recognition process of the stored items is carried out, this is particularly advantageous.

If a data memory is assigned to the detection arrangement, all changes to the stored items or the storage location can be recorded, logged and saved. This is particularly advantageous in the case of embodiments which provide for a time-interrupted connection to the warehouse center, since new data can be stored in this way if data transmission is not possible or desired at this time. However, it can also be used as unchangeable, tamper-proof memory if this is necessary for security reasons, for example.

The method of triggering a recognition process during continuous weight monitoring when a weight change takes place is advantageous for the reason that hardly any or no energy needs to be consumed to monitor the weight. If no storage or removal takes place, the consumption of the detection arrangement is reduced to a minimum. The exact number and timing of recognition operations may vary depending on the type of embodiment. For example, it can be advantageous to carry out a recognition process immediately if the weight changes and to carry out a further recognition process after the manipulation process if the weight remains unchanged for a certain period of time in order to detect any incorrect measurements.

If a stored item is searched for, a protocol as described above can be used by directing a localization location from the warehouse center to one or more detection arrangements which, depending on this signal, mark the searched storage location with order signals via light and/or acoustic sources. When the stock is changed, the detection arrangements can transmit corresponding signals to the warehouse center, for example to verify the correct implementation of the storage process or to report incorrect storage processes.

In the following, the present invention will be explained in more detail on the basis of the embodiment variant depicted in the FIGURE, wherein:

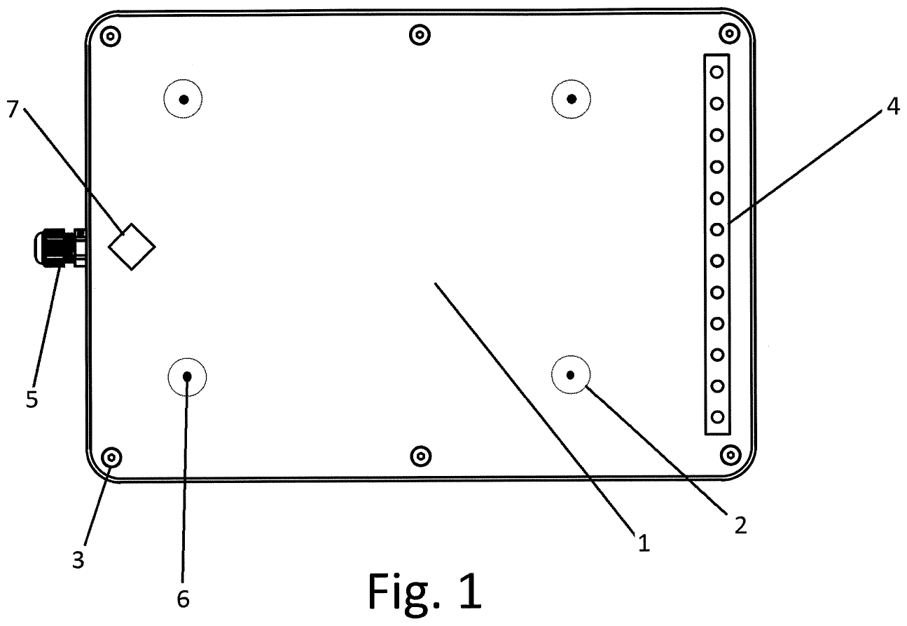

FIG. 1 shows a plan view of an embodiment of a detection arrangement in accordance with the invention.

FIG. 1 discloses a representation of an embodiment according to the invention from above. The plate-shaped detection arrangement has a surface 1 for placing the stored items on it and stands on four feet 2, to which weight sensors 6 are assigned. Four weight sensors 6, to which weighing electronics are assigned, are used in the embodiment shown. The values of the weight sensors 6 are added by the weighing electronics or further processed as required. The illustrated embodiment is designed in a flat manner, but it should be emphasized that this is only one of many variants. Thus, it is also conceivable to form the detection arrangement like a box, which can be filled with stored items. On one side, the detection arrangement has a light source 4 in the form of an LED strip, which can be switched on or made to blink, for example, when a detection signal is received by the detection arrangement. In addition, on the side opposite the light source 4, there is a connection 5 for a power supply and/or data line. On the same side there is a further sensor 7 in the form of an RFID recognition sensor in the middle of the detection arrangement. If the measured values of the weight sensors 6 change, this is registered and evaluated by the weighing electronics and, if a minimum value is exceeded, a corresponding signal is sent to the other sensor 7, which detects an RFID transmitter on the item to be weighed or on its packaging, envelope or pallet. Ideally, the item to be weighed should be placed on the scale in such a way that the RFID transmitter is close to the RFID recognition sensor 7.

1. A storage system comprising:
at least one storage location configured and arranged for storing an item;
at least one detection arrangement is assigned to the at least one storage location and configured and arranged for identifying the item stored at the assigned storage location, the at least one detection arrangement including
at least one weight sensor; and
at least one further sensor configured and arranged for identifying the item, wherein the at least one weight sensor is communicatively coupled to the at least one further sensor, and the at least one weight sensor is configured and arranged to trigger a recognition process of the at least one further sensor in response to a change in the measured weight; and
an operatively separable interface arranged between the at least one detection arrangement and the at least one storage location, so that the at least one detection arrangement is further configured and arranged to be separated from the at least one storage location and is therefore mobile.

2. The storage system according to claim 1, characterized in that at least one further sensor is further configured and arranged to detect a further state variable of the item.

3. The storage system according to claim 1, characterized in that the at least one further sensor is further configured and arranged to operate in a rest state activated between the identifying and recognition processes.

4. The storage system according to claim 1, characterized in that the at least one further sensor is one of the following: an RFID sensor, a radio sensor, an optical sensor, in particular a barcode and QR code reader, and a magnetic sensor.

5. The storage system according to claim 1, characterized in that the at least one further sensor is further configured and arranged to carry out an identification of the item by reading an identification means attached to the item or a transport cover of the item.

6. The storage system according to claim 1, characterized in that the at least one detection arrangement is communicatively coupled to a warehouse center and is configured and arranged to exchange information therebetween.

7. The storage system according to claim 1, further including at least one light and/or acoustic source on the detection arrangement.

8. The storage system according to claim 6, characterized in that the light and/or acoustic source is configured and arranged to be activated in response to a localization signal from the warehouse center.

9. The storage system according to claim 1, characterized in that the at least one storage location is identifiable by the detection arrangement.

10. The storage system according to claim 1, further including a data memory assigned to the at least one detection arrangement.

11. The storage system according to claim 1, further including an energy storage device assigned to the at least one detection arrangement.

12. The storage system of claim 2, wherein the at least one further sensor is further configured and arranged to operate in a rest state activated between the identifying and recognition processes.

13. The storage system of claim 3, wherein the at least one further sensor is one of the following: an RFID sensor, a radio sensor, an optical sensor, in particular a barcode and QR code reader, and a magnetic sensor.

14. The storage system of claim 4, wherein the at least one further sensor is further configured and arranged to carry out an identification of the item by reading an identification means attached to the item or a transport cover of the item.

15. The storage system of claim 5, wherein the at least one detection arrangement is communicatively coupled to a warehouse center and is configured and arranged to exchange information therebetween.

16. The storage system of claim 6, further including at least one light and/or acoustic source on the detection arrangement.

17. The storage system of claim 16, wherein the light and/or acoustic source is configured and arranged to be activated in response to a localization signal from the warehouse center.

18. The storage system of claim 8, wherein characterized in that the at least one storage location is identifiable by the detection arrangement.

19. The storage system of claim 9, further including a data memory assigned to the at least one detection arrangement.

20. The storage system of claim 10, further including an energy storage device assigned to the at least one detection arrangement.
